(19) United States
(12) Patent Application Publication
(10) Pub. No.: US 2021/0166580 A1
(43) Pub. Date: Jun. 3, 2021

(54) Virtual Training Method

(71) Applicant: NWS SRL, Verona (IT)

(72) Inventor: Stefano MAZZI, Verona (IT)

(21) Appl. No.: 16/772,817

(22) PCT Filed: Dec. 16, 2018
(86) PCT No.: PCT/IB2018/060151

§ 371 Date: Jun. 15, 2020

(30) Foreign Application Priority Data
Dec. 20, 2017 (EP) 17208967.4

(51) Int. Cl. G09B 19/00; G02B 27/01; G06F 3/16

(52) U.S. Cl. CPC G09B 19/003; G02B 2027/0178; G06F 3/167; G02B 27/017

(57) ABSTRACT

A virtual guided training method for an operator user responsible for carrying out operational interventions in at least one area or areas of an industrial production machinery including the steps of: registration by said operator user on access and control means of said industrial machinery; —provision of wearable visualization and voice control means, and wearing by said user operator of said wearable means in order to allow to check and display on said wearable means, alarm signals and indications in order to reach said intervention areas; —performing of at least one operational intervention in correspondence of said area or areas with instructions on steps to be performed, given to the operator user directly on said wearable visualization and command means worn by said user; —control and final verification of the intervention performed with acquisition and storage of final data on said access and control means.

The present invention relates to a virtual guided training method.

In particular, the subject invention relates to an operating methodology which is advantageously used during production, maintenance, calibration and/or safety or emergency control of installations, equipments or industrial machines in general, like to for example, machines operating in the production of chemical/pharmaceutical products, to which the following description will make explicit reference without losing its generality.

The aim of the present invention is to provide a virtual method, preferably with augmented reality technology, which allows remote driving of maintenance operators and conduction or emergency of industrial plants according to precise sequential operating procedures to be executed with instructions given step by step, and then exempting them from harmful and dangerous errors of interpretation that could compromise the functioning of plants even for consistent periods of time.

Another aim of the present invention is to provide a method able to clearly and safely identify the operator who will take in charge the operation to be carried out, such identification being done through personalized accesses of recognition in accordance with the regulations in force in the field of information security. A further aim of the present invention is to provide a method able to allow driving the assigned personnel, directly and with timeliness, towards specific areas of industrial plants or machines where operational and/or maintenance interventions are required.

The structural and functional characteristics of the present invention and its advantages with respect to the known art will result in an even more clear and evident way from the underlying claims, and in particular from an examination of the following description, made with reference to the attached Figures, which show a preferred but non-limiting schematic embodiment of a system implementing the subject virtual guided training method and in which:

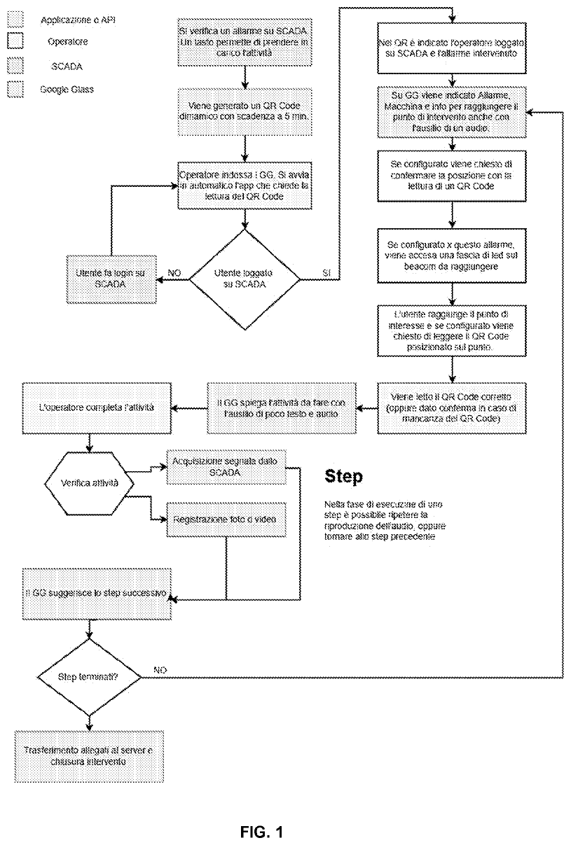

FIG. 1 shows schematically and in blocks the system subject of the present invention;

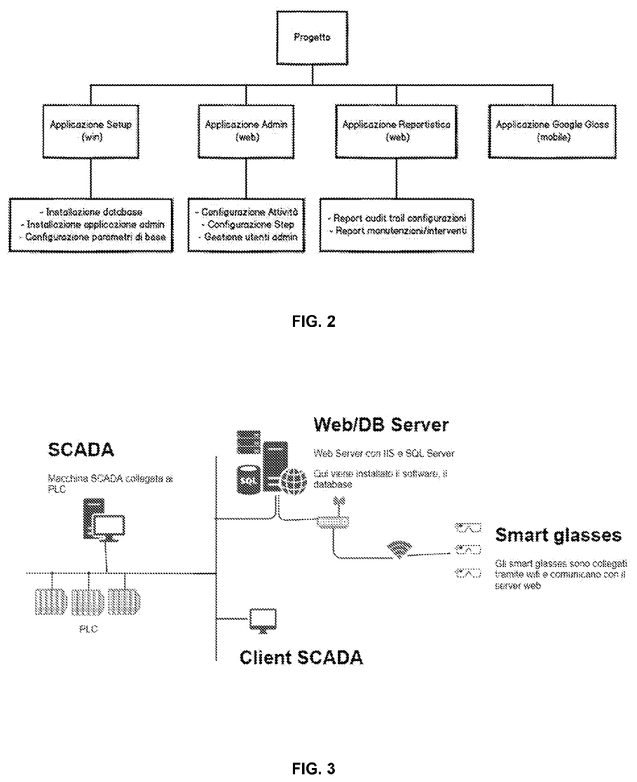

FIG. 2 also shows schematically and in blocks one application of the subject system;

FIG. 3 shows a schematic view of operating components of the subject system; and

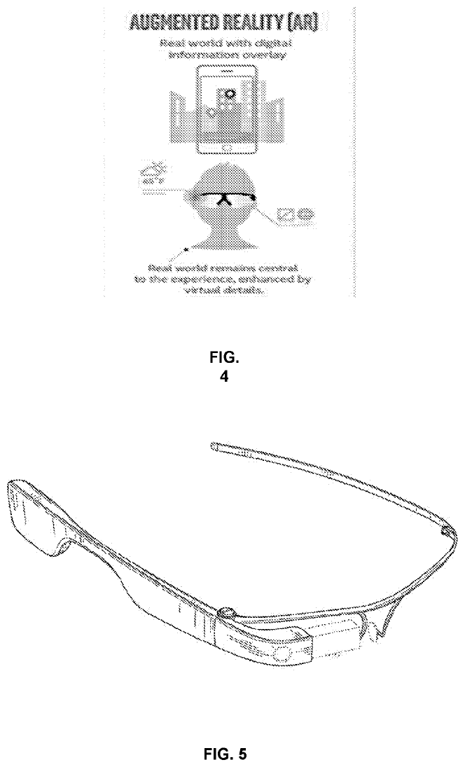

FIGS. 4 and 5 are respective schematic views of some components of the system subject of the present invention.

With reference to the attached FIGS. 1 to 5, the virtual system which preferably uses an augmented reality technology (FIG. 4), implementing the method of the present invention, is able to be advantageously used during production, maintenance, calibration and/or safety or emergency control of plants, industrial equipments or machines, in order to allow an optimal remote driving method for operators involved in maintenance, management or emergency operations of the aforementioned industrial plants/equipment/machines according to precise sequential operative procedures to be carried out with precise and safe instructions provided step by step to the operators themselves.

Preferably, but not limited to, the aforementioned industrial machines (which are known and not shown) are those used and operating in the field of production and packaging of chemical/pharmaceutical products, such as, machines for filling liquids or powders in containers or bottles, blistering machines for the production of blister packs, or equivalent.

As indicated in FIGS. 1, 2 and 3, the subject system preferably comprises a SCADA unit (Supervisory Control And Data Acquisition), connected to at least one PLC board of an industrial machine, to proximity sensor means (for example Beacon) able to be previously positioned at certain PoI points (Point of Interest) of industrial machines, visualization and vocal command wearable means (eg Smart glasses, Smartwatch, or equivalent means—FIG. 5) suitable for being worn by operators and portable electronic devices (Tablet, Smartphone, PC etc.) provided with their own operating systems (Android, iOS, Windows etc.) and connected to the aforementioned wireless network wearables and a web server unit.

In the event of maintenance, management, emergency or similar operations to be carried out on industrial machines, the subject method provides for the following operational steps:
registration (user login with suitable password entry) on SCADA unit by the industrial machine operator and commissioning with the generation of a dynamic code (QR code) and activation of a special application

(App) on a cited portable electronic device;

wearing by the operator of the visual means and voice command, resulting in subsequent display on the mentioned wearable means of alarm signals and indication for reaching the precise location (POI Point of Interest) or area of the plant/equipment where intervention is necessary, and with further actuation of light rays on the aforementioned proximity sensor means (beacon) in order to further facilitate the rapid and effective achievement of the intervention area itself;
execution of the intervention until its successful completion, with constant and precise instructions about the steps to be carried out, given to the operator directly on the visual and command means worn by the operator himself; also preferably videos and/or photos are made of the intervention in progress,

control and final verification of the intervention performed with acquisition and storing of final data on the SCADA unit and then on the mentioned central web server unit.

1. A virtual guided training method for an operator user responsible for carrying out operational interventions in at least one area or areas of industrial production machines including the phases of: registration by said operator user on access and control means of said industrial machines;
provision of wearable visualization and voice control means, and wearing by said user operator of said wearable means in order to allow to check and display on said wearable means, alarm signals and indications in order to reach said intervention area;
execution of at least one operational intervention in correspondence of said area or areas with instructions on the steps to be performed given to the user operator, directly on said display and command means worn by said user;
control and final verification of the intervention performed with acquisition and storage of final data on said access and control means.

2. The method according to claim 1, characterized in that said recording step is carried out on a control unit connected to at least one electronic card of said industrial machines, with generation of a dynamic code and activation of a suitable application on a portable electronic device.

3. The method according to claim 1 characterized in that said visualization on said wearable means comprises a further phase of actuation of light rays on proximity sensor means arranged in correspondence with said area or areas of intervention on said machine.

4. The method according to claim 1, characterized in that it comprises a further step of making videos or photos of said operative intervention.
